(19) United States
(12) Patent Application Publication
(10) Pub. No.: US 2026/0016359 A1
(43) Pub. Date: Jan. 15, 2026

(54) EMISSION MONITORING

(71) Applicant: CONOCOPHILLIPS COMPANY, Houston, TX (US)

(72) Inventor: Shamim SULEMAN, Houston, TX (US)

(73) Assignee: CONOCOPHILLIPS COMPANY, Houston, TX (US)

(21) Appl. No.: 19/267,938

(22) Filed: Jul. 14, 2025

Related U.S. Application Data
(60) Provisional application No. 63/671,499, filed on Jul. 15, 2024.

(51) Int. Cl. G01M 3/04; G08C 17/02

(52) U.S. Cl. CPC G01M 3/04; G08C 17/02

(57) ABSTRACT

The disclosure describes a hatch clamp assembly that is a pipe clamp or cap sensor unit attached to a thief hatch and a chemical storage tank to detect, analyze and correct emission from the storage tank. The hatch clamp assembly creates an enclosure for capturing emissions from the storage tank, and sensors to monitor gas emissions attached to the hatch clamp assembly provide early detection of emission of gases.

### PRIOR RELATED APPLICATIONS

This application claims priority to 63/671,499, filed Jul. 15, 2024 and incorporated by reference in its entirety for all purposes.

### FEDERALLY SPONSORED RESEARCH STATEMENT

Not applicable.

### FIELD OF THE DISCLOSURE

The disclosure generally relates to a system for detecting and correcting emissions from a thief hatch release. The system includes clamps of varying format with sensors that attach to existing thief hatches. Emissions from the tank are detected using the sensors thereby providing early detection of greenhouse gas emissions.

### BACKGROUND OF THE DISCLOSURE

In a rapidly warming global environment, it is important to reduce greenhouse gas emissions wherever possible, and the oil and gas industry is fully engaged in efforts to reach net zero. Equipment leaks in oil and gas operations, commonly referred to as “fugitive emissions,” are unintentional emissions that occur from equipment components such as connectors, valves, open-ended lines, pressure relief valves, and storage tank thief hatches. There are millions of such components, all prone to unintended leaks throughout the oil and gas supply chain and requiring continuous monitoring. Leaks can be repaired when found, but many components are prone to eventually leaking again.

In many hydrocarbon facilities, almost 50% of all fugitive emissions are from storage tanks. Storage tanks are typically fitted with thief hatches—a pressure safety device that is used to provide access to the tank for sampling and measuring the level of a tank, as well as to prevent excess pressure build up in the tank. The thief hatch has spring-loaded seals and when pressure reached a predefined setpoint, the pressure relief disk lifts, thereby allowing the gases to release into the atmosphere. The thief latch may also be connected to a pressure gauge and/or an alarm. See e.g., FIGS. 1A and 1B, described in detail later in the disclosure.

Equipment companies and producers have been working together to install better and tighter sealing thief hatches for decades, but even the best thief hatch will not seal if it is not closed. It may sound painfully obvious, but unsealed thief hatches are a leading cause of tank emissions due to operator oversight or mechanical failure in the field, enough so that governments are starting to take regulatory action against offenders.

When a thief hatch is left open or more commonly just not latched, emissions can go undetected for extended periods of time if proper emission monitors and sensors are not attached to the thief hatch. For example, a storage tank with leaking or open thief hatches for 100 or more hours can emit volatile organic compounds (VOCs) that exceed the 6 tons per year limit. Leaking storage tank thief hatches also emit flammable gases like methane that can also go undetected.

Some states, including Colorado and California, have passed regulations that require constant checking as well as documentation that each thief hatch in a facility is closed and latched. Major sites in violation have been fined up to $25,000 each day that an operator cannot account for a hatch being closed and properly sealed. Although governmental regulations require periodic checking, emissions still occur because of several factors including inefficient sensors, faulty thief hatch designs, lack of automation, unreliable technology, failure of gaskets due to aging, and the ever-present failure by operators to close or seal the hatch.

U.S. Pat. No. 9,764,893 describes a sensor for securing proper latch position of the thief hatch so that the hatch always closes properly after being opened to remove samples or for other monitoring. A force sensor is positioned between the upper and the lower sealing rings of the flange in the thief hatch, such that the sensor can detect an increase in force between the upper and lower sealing rings when the hatch is closed and latched. The force increase is monitored to ensure hatch closure each time the thief hatch is opened and closed and will sound an alarm if not correctly latched. Further, one embodiment has means for communicating the sensor data to a remote location such as a data or processing center. While an excellent design for new tanks, it is impractical to decommission all older tanks and retrofit them with new thief hatches.

U.S. Pat. No. 11,543,321 described a vent control system attached to a thief hatch that can be accessed and viewed by a human operator while removing samples from the thief hatch. The vent control system contains indicators, sensors and sometimes a camera for easy visual inspection of leaks, and thus ensuring closure of the thief hatch after access. The system may also include a magnetic detector for determining if the hatch is closed, or pressure sensors for determining pressure inside the tank. An open or leaky thief hatch can also be prevented by real-time data monitoring of the hatch status with date/time stamps, alerts to field operations if the hatch malfunctions, followed by corrective actions by field operations. As above, this sophisticated design is great for new tanks, but does not address the problem of the tens of thousands of older tanks already in the field.

Although measures like attaching a sensor to properly latch a thief hatch, and attaching a vent control system viewable by an operator are good practices for a thief hatch, they are still prone to mechanical failure, and without functional wireless communication are dependent on when an operator opens or visits a storage tank. Furthermore, these systems require retrofitting the new thief hatches onto a tank, and the costs for changing all the thief hatches, and the tank downtime are significant hurdles to implementation.

Thus, what is needed in the art are systems that provide a mechanism for early detection of release of gases from a hydrocarbon tank via a thief hatch, so that measures can be put into place for reducing or preventing emissions early on in a system. This system of early detection should be such that it can be fitted with multiple sensors and monitoring devices and function with high efficiency, can be installed with minimum infrastructural cost, can be added on to existing systems without the need for re-creating new systems, i.e. existing older systems can be easily retrofitted. This invention addresses one or more of these needs.

### SUMMARY OF THE DISCLOSURE

Described herein are methods and systems for monitoring emissions from a storage tank by using a pipe clamp sensor or a pipe cap sensor that can be placed in or over an existing thief hatch to create an enclosed space where gas can be monitored. Sensors placed in this enclosed space attached with the pipe clamp externally mounted (over the hatch cover) detect gas release and other parameters including but not limited to recording date and time, temperature, pressure, type of gas, amount of gas, etc. The data is then communicated to an operator and emission is detected even when the thief clamp is closed. Proper adjustments and measures can then be taken to prevent further emissions. Thus, this method provides an early emission detection method before build-up or release of harmful gases by the thief clamp, without any downtime for replacement of existing thief hatches.

The hatch clamp assembly described herein comprises a pipe clamp or cap, seals, and one or more emission detector sensors attached to the pipe clamp or cap. Existing thief hatches on storage tank can easily be fitted with these sensor-equipped pipe components to create a hatch clamp assembly of sensor-equipped pipe clamps/caps and an existing thief hatch. The pipe clamp sensor is configured to fit the thief hatch cover over the vertical annular flange of the base in an “inside-the-hatch” style. The pipe cap sensor by contrast fits over the entire thief hatch in an “over-the-hatch” style.

These gas sensors may be able to detect specific gases or be agnostic and function to detect e.g., oxidation/reduction, photoionization, ultrasound, pressure, and the like. Sensors include combustible gas sensors, photoionization detectors, infrared point sensors, infrared imaging sensors, ultrasonic sensors, electrochemical gas sensors, catalytic bead (pellistor) sensors, holographic gas sensors, semiconductor gas sensors, metal-oxide-semiconductor (MOS) sensors, and the like.

In one example, a gas monitor is configured to detect common hydrocarbon gases like carbon monoxide (CO), carbon dioxide (CO₂), hydrogen sulfide (H₂S), methane (CH₄), flammable liquid vapors including liquified petroleum gas (LPG), light ends, ethane, propane and butane, and is part of the pipe clamp sensor or pipe cap sensor. Based on the tank contents, the gas monitor selected for use can be based on the most volatile emissions gas from the tank. For example, if the hydrocarbon in storage tank is rich in hydrogen sulfide (H₂S), a separate H₂S monitor attached to the hatch clamp assembly may be preferred for safety. As another example, a natural gas tank may be equipped with a methane sensor. In other examples, the sensor may detect light ends and/or CO₂.

In other examples, a time and date sensor and/or a temperature sensor may also be included with the gas sensor to collect and record date stamp and/or temperature for emission data. Customizable and commercially available gas sensors are available that can be easily attached to the pipe clamp sensor or pipe cap sensor.

The pipe clamp sensor or pipe cap sensor as described herein can be fitted on both underground and above-ground storage tanks. Furthermore, any commercially available storage tank with a thief hatch can be fitted with the pipe clamp sensor or pipe cap sensor to form a hatch clamp assembly. For example, floating roof oil tanks, fixed roof oil tanks, bunded tanks, single skin or double skin tanks, can all be retrofitted to have the hatch clamp assembly by merely adding the pipe clamp sensor or pipe cap sensor to the existing thief hatch. Further, these devices are designed such that existing pipe and sensor components can be combined to make the devices, obviating the need to manufacture new hardware for this use.

The pipe clamp used for the hatch clamp assembly as described herein may be standard pipe clamps, split banks, U-bolts, saddle clamps, heavy-duty clamps, and the like. For large storage tanks containing flammable material or fluid with low vapor pressure, heavy-duty pipe clamps are preferred. A stainless steel or zinc plated saddle pipe clamp may also be used for a tight fit. Alternatively, a dedicated clamp may be designed or manufactured, rather than using an existing commercially available clamp, and the same is true of the pipe cap.

In the examples presented, fluoropolymer seals like VITON® may be used on the edges of the pipe clamp or pipe cap to create an enclosed space for trapping emissions. VITON® works well in a range of temperatures between −45° C. to 145° C. (˜−49° F. to 300° F.) and is highly water and chemical resistant. However, substitutions like rubber, Teflon, ethylene propylene diene monomer (EDPM), AFLAS®, and others may also be used as gasket materials. In some instances, the gasket may be optional if the thief hatch already holds gas until build up.

Although the disclosure is described in terms of hydrocarbon storage tanks, it is understood that any chemical stored in a storage tank with potential leakage can be monitored by a thief hatch fitted with a pipe clamp or pipe cap sensor of the present disclosures.

The invention includes and one or more of the following embodiments in any combination(s) thereof:
A sensor for adding to a separate thief hatch for emission monitoring, said sensor comprising either a pipe clamp sensor or a pipe cap sensor, said pipe cap sensor comprising a) a pipe cap configured to fit over a separate thief hatch on a separate tank; b) a gasket on a bottom open edge of said pipe cap to trap gas between said tank and said pipe cap when said pipe cap is affixed over said separate thief hatch; and c) a sensor package operably mounted inside said pipe cap and comprising i) a gas sensor configured to detect gas, and ii) a communicator configured to communicate detection of said gas to an operator, said pipe clamp sensor comprising: a) a pipe clamp configured to fit over a vertical annular flange on a base of a separate thief hatch; b) an optional gasket on one or more edges of said pipe clamp to trap gas therein when said thief hatch is closed and latched; and c) a sensor package operably mounted to said pipe clamp and comprising i) a gas sensor configured to detect gas, and ii) a communicator configured to communicate said detected gas to an operator.
A pipe clamp sensor for adding to a separate thief hatch for emission monitoring, said pipe clamp sensor comprising: a) a pipe clamp configured to fit over a vertical annular flange on a base of a separate thief hatch; b) an optional gasket on one or more edges of said pipe clamp to trap gas therein when said thief hatch is closed and latched; and c) a sensor package operably mounted to said pipe clamp and comprising i) a gas sensor configured to detect gas, and ii) a communicator configured to communicate said detected gas to an operator.
A pipe cap sensor for adding to a separate thief hatch for emission monitoring, said pipe cap sensor comprising: a) a pipe cap configured to fit over a separate thief hatch on a separate tank; b) a gasket on a bottom open edge of said pipe cap to trap gas between said tank and said pipe cap when said pipe cap is affixed over said separate thief hatch; and c) a sensor package operably mounted inside said pipe cap and comprising i) a gas sensor configured to detect gas, and ii) a communicator configured to communicate detection of said gas to an operator.
A hatch-clamp assembly comprising any pipe clamp sensor herein described fitted over a vertical annular flange on a base of a thief hatch on a tank, a cover of said thief hatch fitting over said pipe clamp sensor and allowing gas from said tank to be trapped and detected by said gas sensor and said communicator communicating said detected gas to said operator.
A hatch-clamp assembly comprising any pipe cap sensor herein described affixed over a thief hatch on a tank and allowing gas from said tank to be trapped between said tank and said pipe cap sensor and detected by said sensor package.
Any pipe clamp sensor or pipe cap sensor herein described, wherein said gas sensor measures an amount of said gas. The gas sensor is preferably configured for detecting one or more of carbon dioxide (CO₂), methane (CH₄), hydrogen sulfide (H₂S), carbon monoxide (CO), liquified petroleum gas (LPG), light ends, ethane, propane and butane.
Any pipe clamp sensor or pipe cap sensor herein described, wherein said gas sensor is selected from combustible gas sensors, photoionization detectors, infrared point sensors, infrared imaging sensors, ultrasonic sensors, electrochemical gas sensors, catalytic bead (pellistor) sensors, holographic gas sensors, semiconductor gas sensors, metal-oxide-semiconductor (MOS) sensors, and the like.
Any pipe clamp sensor or pipe cap sensor herein described, wherein said sensor package further comprises one or more of i) a time sensor configured to record date and time; ii) a temperature sensor configured to measure and record temperature; iii) an alarm; or iv) a hatch closure sensor configured to detect if said thief hatch is closed, and/or said communicator can comprise a wireless transmitter for transmitting sensor package data to another site. Sensor package data includes at least detected gas data, and may include one or more of temperature data, gas identity and or amounts, time and date data, hatch closure data, pressure data, and the like.
Any pipe clamp sensor or pipe cap sensor herein described, wherein said pipe clamp is a standard pipe clamp, split bank clamp, saddle clamp, or heavy-duty clamp.
Any pipe clamp sensor or pipe cap sensor herein described, wherein said gasket is present and comprises a fluoropolymer.

As used herein, “emissions” is a discharge of volatile fluids, gases and vapors released to the atmosphere. Emission is typically measured in concentration of the volatile fluids, gases and vapors, most commonly in parts per million (ppm). Commonly monitored gases for emission are greenhouse gases (GHGs), water vapor, CO₂, CH₄, nitrous oxide (N₂O), hydrofluorocarbons (HFCs), perfluorocarbons (PFCs), H₂S, etc.

As used herein a “pipe clamp” is an annular ring that fits over a pipe. It may be integral, or it may be broken into one or two or more parts and with latches, toggles, bolts or other closing mechanism, depending on the style of pipe clamp.

As used herein a “pipe cap” is an annular ring that fits over a pipe that is also fitted with a cover. These (ring and cover) are typically integral pieces, but the cover may also be separate and hinged to the pipe, or threaded onto the pipe. The pipe cap may have a base flange or not, depending on the affixing means.

The use of the word “a” or “an” in the claims or the specification means one or more than one, unless the context dictates otherwise.

The term “about” means the stated value plus or minus the margin of error of measurement or plus or minus 10% if no method of measurement is indicated.

The use of the term “or” in the claims is used to mean “and/or” unless explicitly indicated to refer to alternatives only or if the alternatives are mutually exclusive.

The terms “comprise”, “have”, “include” and “contain” (and their variants) are open-ended linking verbs and allow the addition of other elements when used in a claim. The phrase “consisting of” is closed and excludes all additional elements. The phrase “consisting essentially of” excludes additional material elements but allows the inclusions of non-material elements that do not substantially change the nature of the invention, such as instructions for use, buffers, and the like.

Any claim or claim element introduced with the open transition term “comprising,” may also be narrowed to use the phrases “consisting essentially of” or “consisting of,” and vice versa. However, the entirety of claim language is not repeated verbatim in the interest of brevity herein.

The following abbreviations are used herein:

TABLE 1
Abbreviations

| ABBREVIATION | TERM |
|---|---|
| EDPM | Ethylene propylene diene monomer |
| GHG | Greenhouse gases |
| HFC | Hydrofluorocarbon |
| LPG | Liquified petroleum gas |
| PFC | Perfluorocarbons |
| VOC | Volatile organic compounds |

### BRIEF DESCRIPTION OF THE DRAWINGS

FIG. 1A (Prior Art) Schematic of a typical thief hatch for a storage tank in the closed position.

FIG. 1B (Prior Art) Schematic of a typical thief hatch for a storage tank in the open position.

FIG. 1C (Prior Art) cross section of a thief hatch showing how the pressure relief functions work. In the first panel, the pressure is normal, and the hatch is closed. In the second panel when pressure increases, it compresses the pressure spring sufficiently to lift the pressure pallet allowing excess gas to vent. In the third panel, the tank is at negative pressure, pulling down on the vacuum spring via the vacuum stem, thereby pulling the vacuum pallet down, allowing air to enter, thus balancing the pressure.

FIG. 2 a simplified schematic of an inside-the-hatch assembly aka pipe clamp-sensor.

FIG. 3 a simplified schematic of an over-the-hatch assembly aka pipe cap-sensor.

FIG. 4A-4F Prototypes of an inside-the-hatch pipe clamp-sensor.

FIG. 5A-5F Prototypes of an over-the-hatch pipe cap-sensor.

FIG. 6A (Prior Art) exemplary pipe clamps.

FIG. 6B (Prior Art) exemplary pipe caps.

### DETAILED DESCRIPTION

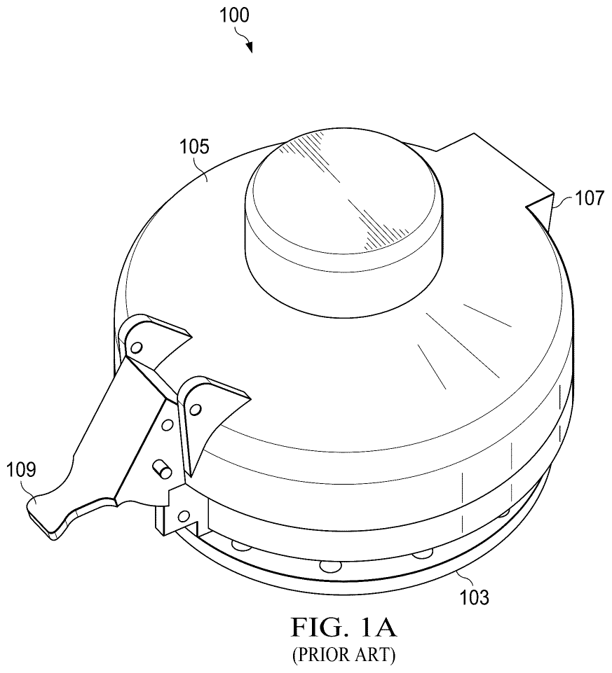

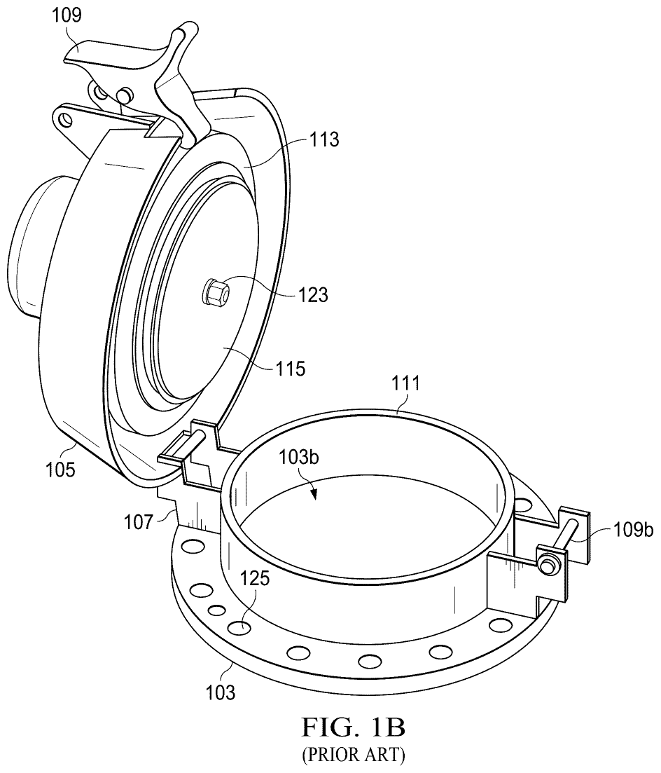

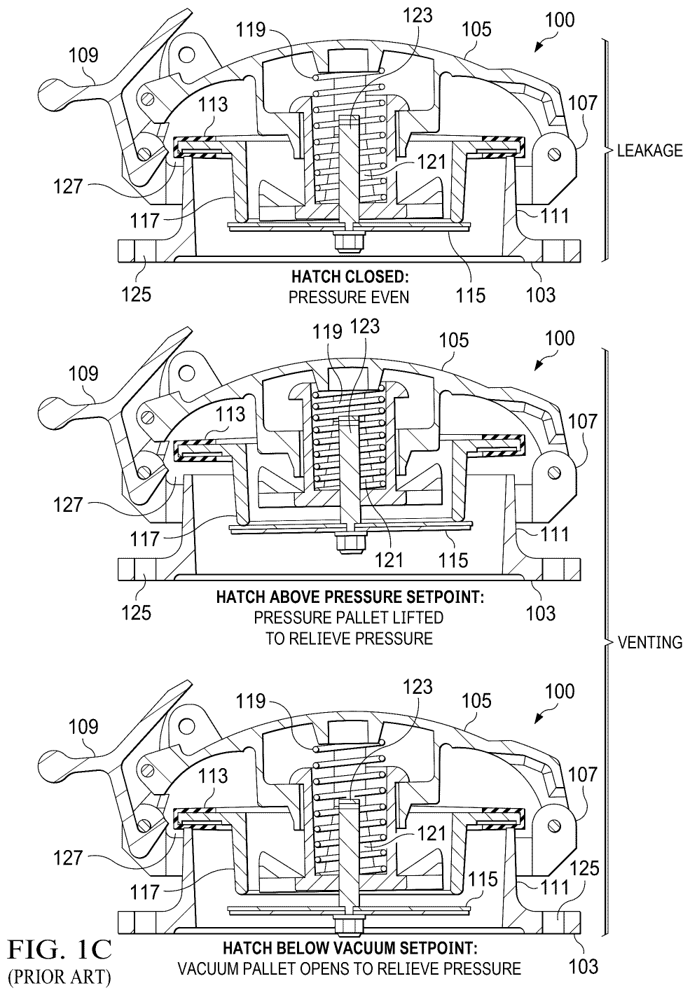

A schematic of a typical prior art thief hatch is shown in FIG. 1A-C. FIG. 1A shows a closed thief hatch 100 with a cover 105 over a flange base 103. A hinge 107 attaches cover 105 to the flange base 103. A latch 109 keeps the cover 105 closed.

FIG. 1B shows a view of an open thief hatch, where cover 105 is open. A latch catch 109b that keeps the cover 105 closed is shown, along with a sealing ring 111 on the flange base 103. Pressure gasket 113 on the cover 105 can be seen in this view. We can also see vacuum pallet 115 and vacuum stem 123 as well as bolt holes 125 and the flange base opening 103b though which an operator may access the tank interior.

FIG. 1C is a cross section, where the action of vacuum spring 121 and pressure spring 119 is visible. In the first panel, the thief hatch 100 is closed and the pressure is within tolerance.

In the second panel, pressure in the tank increases, compressing pressure spring 119. This lifts the pressure pallet 117, thereby separating gasket 113 from sealing ring 111. This allows excess gas to escape via vent 127.

In the third panel, the pressure in the tank is negative, thus pulling down on vacuum spring 121 via vacuum stem 123. This pulls down vacuum pallet 115, opening a space for air to enter, again via vent 127 and travelling between the now open space between pressure pallet 117 and vacuum pallet 115.

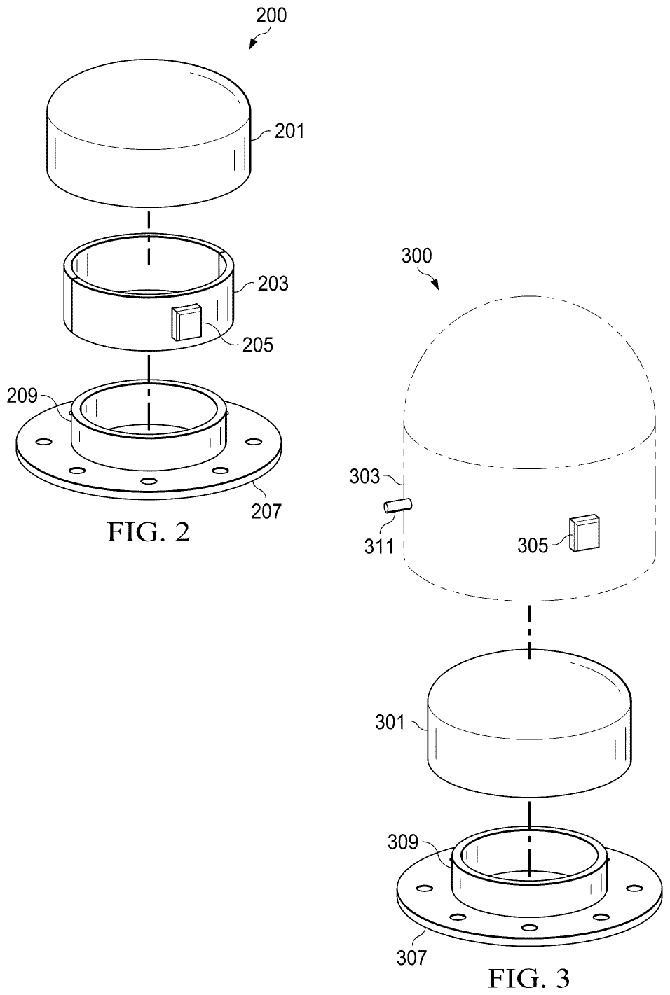

FIG. 2-3 show simplified embodiments of the hatch clamp assembly, wherein the thief hatch latch and hinge and other details are omitted for clarity.

In FIG. 2, we see hatch clamp assembly 200 comprising the thief hatch cover 201 and base 207 which includes annular flange 209. The lock and hinge are omitted, and seals on the pipe clamp are also omitted for clarity. Pipe clamp 203 fits over flange 209 and is equipped with sensor package 205, which functions to detect gas and communicate that status to an operator. The sensor package may be positioned as needed, preferably inside the pipe clamp, although it may be largely on the outside with just sensor elements on the inside.

In some instances, it would also work to put a sensor package outside the pipe clamp. In this embodiment, gas will be trapped right up until the thief hatch emits, and then one may detect a sudden decrease in gas level.

FIG. 3 shows an embodiment that fits over-the-hatch, as opposed to the inside-the-hatch embodiment of FIG. 2 and may be suitable for smaller thief hatches with reduced inside space. It may still be made from a pipe clamp by adding a cover, but an existing pipe cap requires less retrofitting as it already has a cover or cap closing off one end.

In FIG. 3 the assembly 300 comprises thief hatch cover 301, base 307 and the vertical annular flange 309, the same as in FIG. 2. Here a pipe cap or shroud 303 has a sensor package 305 on an inner surface. Optional gas sample tube 311 allows the operator to sample gases if desired and may also be included on the device of FIG. 2 should space permit. As above, seals, hinge and latch are omitted for clarity.

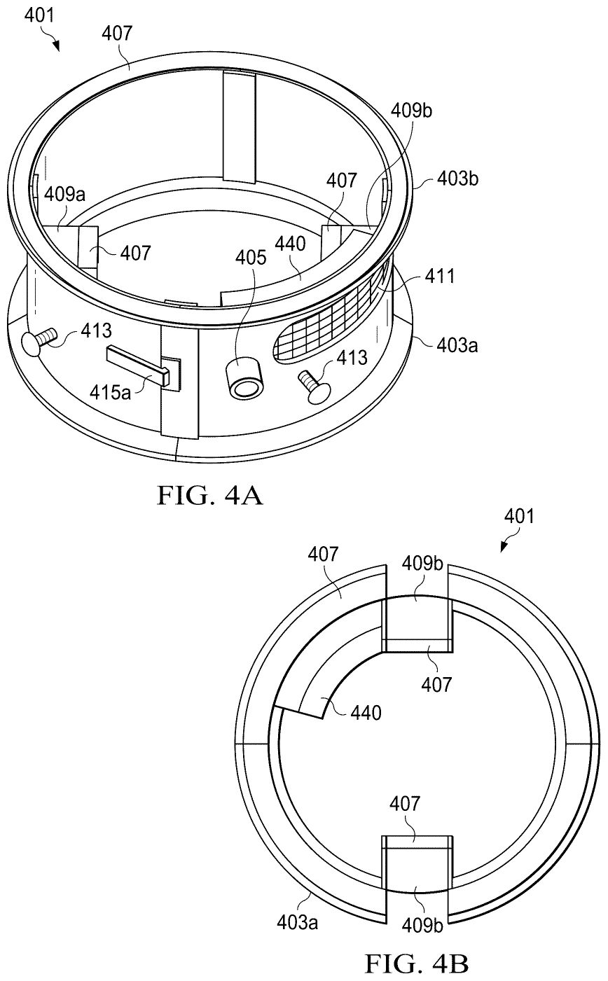

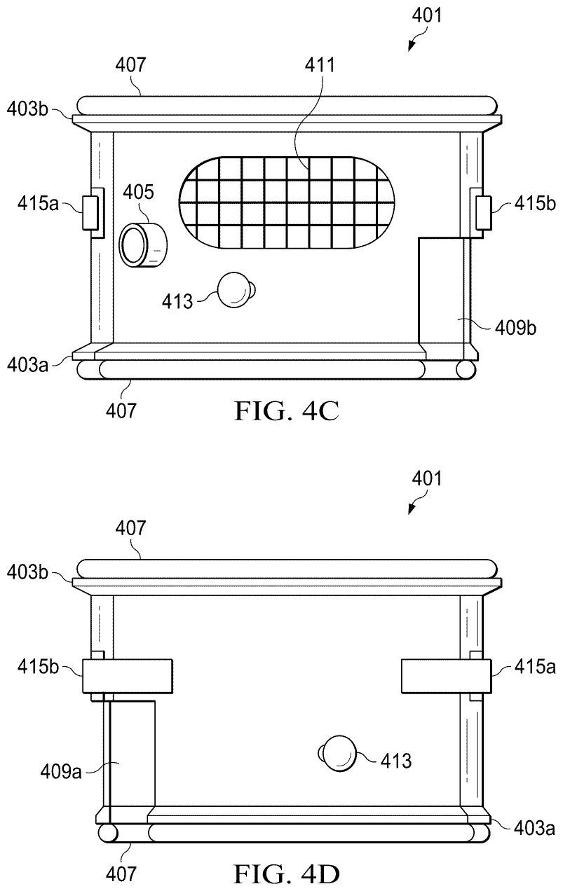

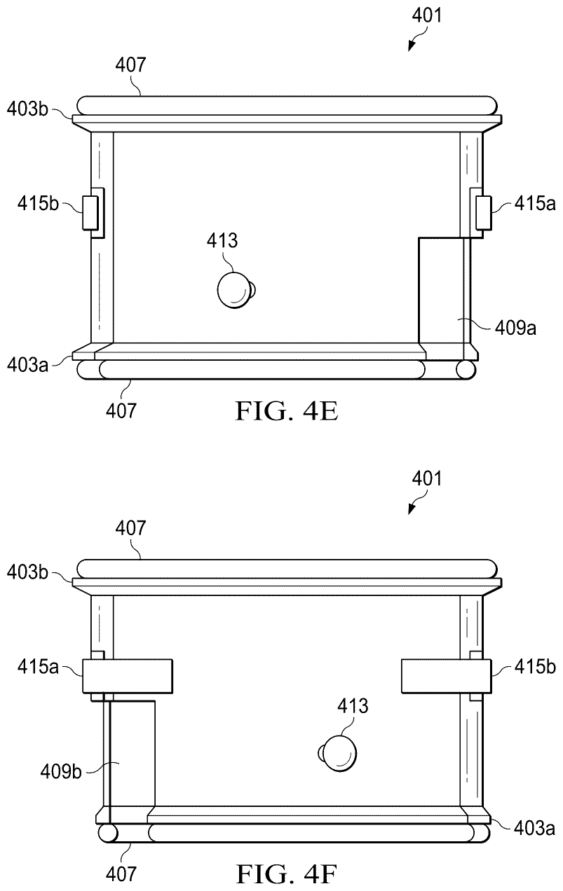

FIG. 4A-4F include additional detail of an inside-the-hatch prototype version of the thief hatch assembly. Here, a pipe clamp 401 with offset dual latches 415a, 415b (415b is in the back in FIG. 4A, and is shown in the view of FIG. 4C) was used. This pipe clamp has flanges 403a, 403b at both upper and lower ends. Bolts 413, female couplings 405, and screen 411 can be seen in FIG. 4A. Sensor package 440 is seen inside along with gasket 407.

FIG. 4B shows a modified pipe clamp by cutting out holes 409a and 409b to fit over the latch and hinge of a specific thief hatch, and all edges were lined with gasket 407. Sensor package 440 was added to the inside.

Also seen in this initial prototype, shown in FIGS. 4C, 4D, 4E and 4F are female couplings 405, screen 411 (seen in FIG. 4C), and 4 bolts 413, one or more of which may be omitted in a final product. Some of these features are only present due to the clamp selected for the prototype, and are not needed or contrary to purpose.

In use, the latches 415 are opened, and the clamp 401 fitted over the latch and hinge of the thief clamp. The pipe clamp latches are secured, and the thief clamp cover also secured. Gas may be monitored continuously or intermittently in about 5, 10 or 30 minute increments or more, and gas levels reported. A significant drop in gas levels or pressure will occur every time the thief hatch lifts to prevent excess pressure. This may be communicated wirelessly to the operator, and/or an alarm may sound on site. Failure to close or latch the thief clamp may also be detected as gas levels will never increase as the gas will continually escape.

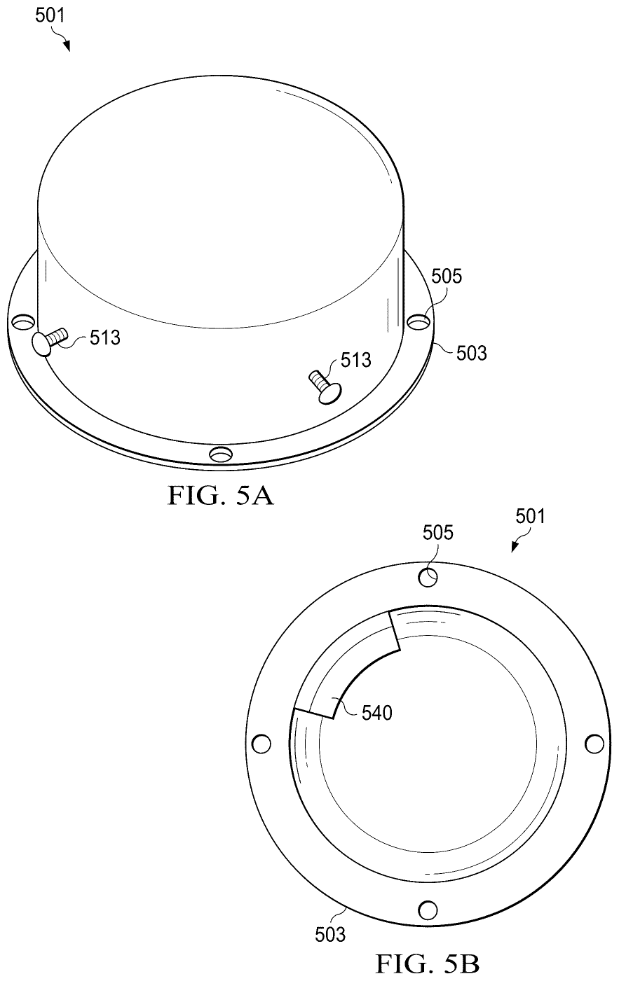

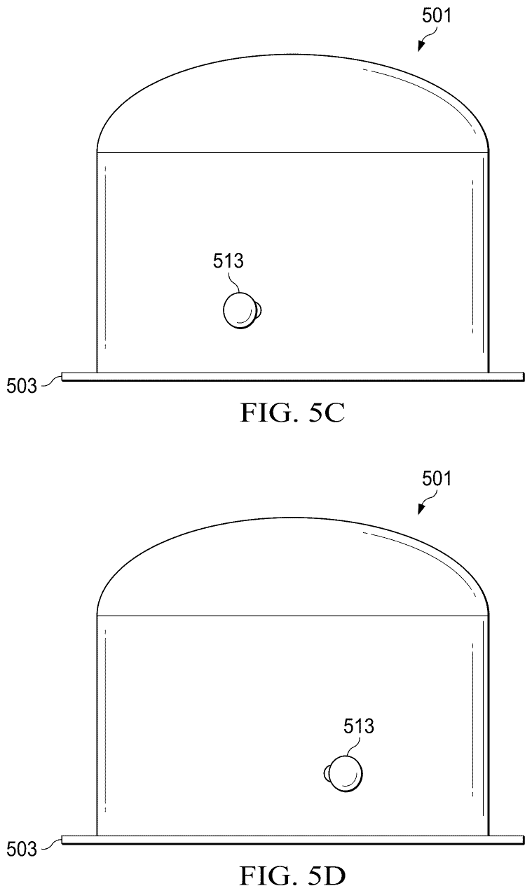

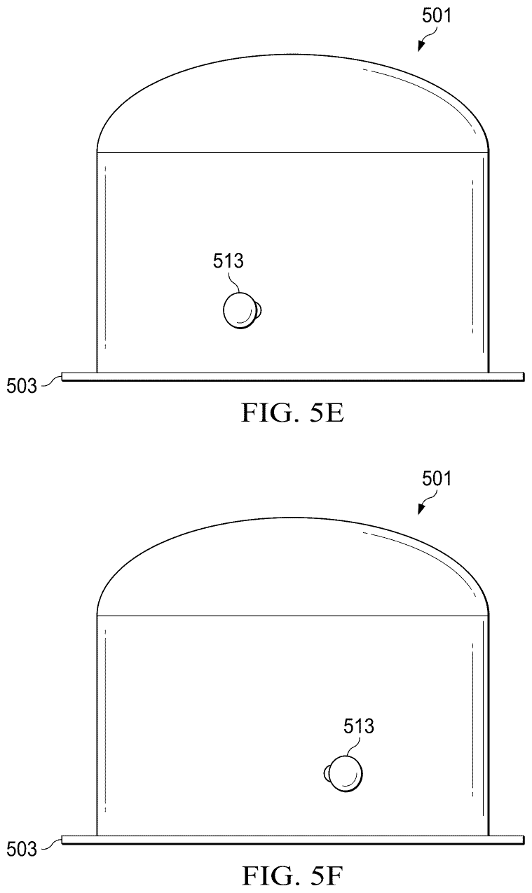

FIG. 5A-F show an over-the-hatch embodiment made with pipe cap 501 with bottom flange 503 lined with gasket 507. FIG. 5A shows bolts 513 and optional bolt holes 505 on flange base 503.

The view in FIG. 5B shows sensor package 540 is inside. Also shown are flange base 503 that has optional bolt holes 505 for securing to the tank (tank not shown) or alternatively flange 503 may be glued thereto. As yet a third option, 3-4 optional bolts 513 may be added through the vertical walls of the pipe cap that may be tightened to grip the cover of the thief hatch, and shown in FIGS. 5C, 5D, 5E and 5F (see FIG. 4 for bolts 413). The pipe clamp is sized as to fit over the entire thief hatch, and no gaps 403 need be added to fit the thief hatch latch or hinge, thus this embodiment is even simpler to make than the inside-the-hatch style.

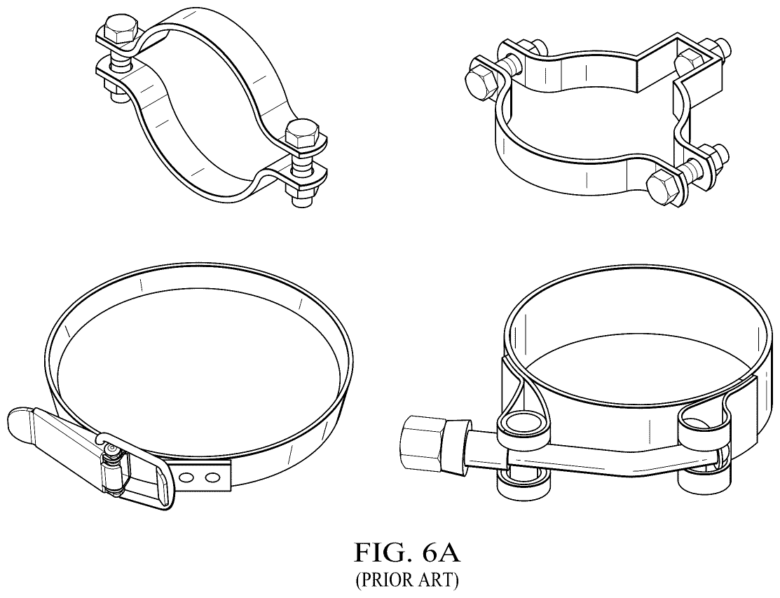

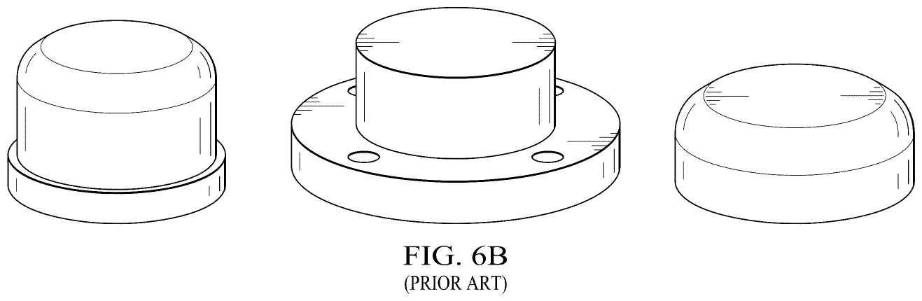

FIG. 6A shows a few examples of pipe clamp styles and FIG. 6B shows a couple of pipe caps, each of which can be modified as described herein to make the sensors.

The examples presented herein are intended to be illustrative only, and not unduly limit the scope of the appended claims. Although the present disclosure and its advantages have been described in detail, it should be understood that various changes, substitutions and alterations can be made herein without departing from the scope of the disclosure as defined in the claims.

The following references are incorporated by reference in their entirety for all purposes:
U.S. Pat. No. 9,296,530 Thief hatch
U.S. Pat. No. 9,764,893 Thief hatch monitoring system
U.S. Pat. No. 11,543,321 Methods and apparatus for leak detection from a thief hatch
Bristow, P.; Kidwell, J. “Open and shut: smart, reliable thief hatch monitoring in tank batteries.” (2022) Valve Magazine (https://www.valvemagazine.com/news/open-and-shut-smart-reliable-thief-hatch-monitoring-in-tank-batteries).

1. A pipe clamp sensor for adding to a separate thief hatch for emission monitoring, said pipe clamp sensor comprising:
a) a pipe clamp configured to fit over a vertical annular flange on a base of a separate thief hatch and inside a cover of said separate thief hatch;
b) an optional gasket on one or more edges of said pipe clamp to trap gas therein when said thief hatch cover is closed and latched; and
c) a sensor package operably mounted to said pipe clamp and comprising i) a gas sensor configured to detect gas, and ii) a communicator configured to communicate said detected gas to an operator.

2. The pipe clamp sensor of claim 1, wherein said gas sensor measures an identity of said gas or an amount of said gas or both.

3. The pipe clamp sensor of claim 1, wherein said gas sensor is configured for detecting one or more of carbon dioxide (CO₂), methane (CH₄), hydrogen sulfide (H₂S), carbon monoxide (CO), liquified petroleum gas (LPG), light ends, ethane, propane, and butane.

4. The pipe clamp sensor of claim 1, wherein said sensor package further comprises a time sensor configured to record date and time.

5. The pipe clamp sensor of claim 1, wherein said sensor package further comprises a temperature sensor.

6. The pipe clamp sensor of claim 1, wherein said sensor package further comprises an alarm.

7. The pipe clamp sensor of claim 1, wherein said communicator comprises a wireless transmitter for transmitting sensor package data to another site.

8. The pipe clamp sensor of claim 1, wherein said pipe clamp is a standard pipe clamp, a split bank, a saddle clamp, or a heavy-duty clamp.

9. The pipe clamp sensor of claim 1, wherein said gasket is present and comprises a fluoropolymer.

10. A hatch-clamp assembly comprising the pipe clamp sensor of claims 1 fitted over a vertical annular flange on a base of a thief hatch on a tank, said cover of said thief hatch fitting over said pipe clamp sensor and allowing gas from said tank to be trapped and detected by said gas sensor and said communicator communicating said detected gas to said operator.

11. A pipe cap sensor for adding to a thief hatch for emission monitoring, said pipe cap sensor comprising:
a) a pipe cap configured to fit over a separate thief hatch on a separate tank;
b) a gasket on a bottom open edge of said pipe cap to trap gas between said tank and said pipe cap when said pipe cap is affixed over said separate thief hatch; and
c) a sensor package operably mounted inside said pipe cap and comprising a gas sensor configured to detect gas and a communicator configured to communicate detection of said gas to an operator.

12. The pipe cap sensor of claim 11, wherein said sensor package comprises a gas sensor for one or more of carbon dioxide (CO₂), methane (CH₄), hydrogen sulfide (H₂S), carbon monoxide (CO), liquified petroleum gas (LPG), light ends, ethane, propane, and butane.

13. The pipe cap sensor of claim 11, wherein said gas sensor is configured to detect one or more gases and to measure an amount of said one or more gases.

14. The pipe cap sensor of claim 11, wherein said sensor package further comprises a time sensor configured to record date and time.

15. The pipe cap sensor of claim 11, wherein said sensor package further comprises a temperature sensor.

16. The pipe cap sensor of claim 11, wherein said sensor package comprises an alarm.

17. The pipe cap sensor of claim 11, wherein said communicator comprises a wireless transmitter for transmitting sensor package data to another site.

18. The pipe cap sensor of claim 11, wherein said pipe clamp is a standard pipe clamp, a split bank clamp, a saddle clamp, or a heavy-duty clamp.

19. The pipe cap sensor of claim 11, wherein said gasket comprises a fluoropolymer.

20. A hatch-clamp assembly comprising the pipe cap sensor of claims 11 affixed over a thief hatch on a tank and allowing gas from said tank to be trapped between said tank and said pipe cap sensor and detected by said sensor package.
